(19) United States
(12) Patent Application Publication
(10) Pub. No.: US 2010/0200363 A1
(43) Pub. Date: Aug. 12, 2010

(54) SYSTEM FOR COMBINING GROUPS OF FLAT OBJECTS

(75) Inventor: Erwin Muller, Durnten (CH)

Correspondence Address: RANKIN, HILL & CLARK LLP, 38210 GLENN AVENUE, WILLOUGHBY, OH, 44094-7808, US

(73) Assignee: FERAG AG, Hinwil (CH)

(21) Appl. No.: 12/670,973

(22) PCT Filed: Jul. 23, 2008
(86) PCT No.: PCT/CH08/00330

§ 371 Date: Apr. 27, 2010

(30) Foreign Application Priority Data
Jul. 30, 2007 (CH) 1214/07

(51) Int. Cl. B65G 47/30

(52) U.S. Cl. 198/418.2

(57) ABSTRACT

A system for combining groups of flat objects includes a matrix-like arrangement of a plurality of group conveyors and a plurality of feed conveyors disposed above the group conveyors, wherein all conveyors are operated continuously and the operation of all group conveyors and all feed conveyors is rigidly coupled. At feed points, which are regions in which a feed conveyor crosses over a group conveyor, group conveyors and feed conveyors are rectified. Both the group conveyors and the feed conveyors can be returned, and the steps for receiving objects by the feed conveyors, for transferring the objects to the group conveyors, and for transferring groups to a removing conveyor or further processing station are strictly synchronized and are selectively performed or suppressed in a controlled manner.

### BACKGROUND OF THE INVENTION

1. Field of the Invention

The invention lies in the field of handling piece goods and relates to a system for putting together groups of flat objects, in particular groups of different, flat objects, in particular printed products such as newspapers or magazines and attachments, which may likewise be printed products (e.g. brochures, cards) or also other flat objects such as for example CDs, DVDs or flat sample sachets.

2. Description of Related Art

According to the state of the art, groups of flat objects, in particular printed products, are put together, for example, by way of adding in each case a further printed product or another flat object to each individual main product (e.g. printed product such as newspaper or magazine) which are conveyed one after the other in a conveyor flow, at feed locations arranged one after another along the conveyor path. Each of the feed locations thereby is assigned to a type of flat object (e.g. printed product) to be fed, and/or to a type of specific, suitably precollected smaller pre-groups of flat objects (e.g. printed products).

The mentioned main products are, for example, conveyed in a loose manner and one after the other, lying on a conveyor rest, and the further objects are stacked thereon. Or the main products, which in this case are folded or stitched printed products, are conveyed in an upright and opened manner and the further objects are inserted therein. Thereby, by way of suspending individual feed steps, it is also possible, at least to a limited extent, to produce so-called individualised groups, that is to say, ones which are different from one another in a limited manner.

Many different systems are used for the mentioned composition of groups of flat objects. The simplest such systems are so-called linear systems with transverse feeds. These, for the arising groups, comprise a row of conveyor compartments which may be conveyed one after the other along an essentially straight-lined conveyor path, as well as a plurality of feed devices with whose help in each case an object is released into each conveyor compartment at successive feed locations. Thereby, the direction in which the objects are fed, is aligned essentially transversely to the conveyor direction in a plan view. If the objects are to be stacked to some extent in an orderly manner in groups, which are to be created with such a system, the conveyor compartments must be conveyed in an intermittent manner, which means in a manner such that they stand still when an object is added, and are only moved between successive feed steps. For creating ordered groups in continuously conveyed conveyor compartments, supply devices are used with a feed direction which is directed equally to the group conveyor direction (the same conveyor directions in a plan view), wherein an object to be fed, directly before depositing into the conveyor compartment, moves essentially synchronously with the conveyor compartment and approaches this from above, and where possible is not released by the feed device until it is already almost finally positioned in the conveyor compartment. Thereby, for creating stack-like groups, it is advantageous to use rests with front or rear walls or abutments as conveyor compartments, and to set the feed speed somewhat larger or smaller than the speed of the rests, in a manner such that each released object is abutted on the front or the rear wall and by way of this is aligned to objects which are already deposited on the rest.

Drum-like devices are used (non-linear systems) for putting together groups of flat objects. In such drums, the groups arise in axially extending conveyor compartments, in which on the one hand they rotate with the drum about the drum axis, and on the other hand are axially displaced, thus are conveyed along a spiral conveyor path. The feed locations are arranged essentially axially next to one another, in a manner such that the arising groups are conveyed past a feed location for example with each rotation about the drum axis. In such systems, the feed direction is directly transverse to the drum axis and somewhat tangential to the drums, thus roughly equally directed to the rotational movement during the release of the objects, which permits the creation of ordered groups in relatively restricted conveyor compartments and with a continuous conveying.

It is suggested to combine a plurality of the above-mentioned linear systems with a transverse supply, thus with an intermittent group conveying, into a matrix-like arrangement and thus to achieve an increase in the capacity, in the publication U.S. Pat. No. 4,484,733 (Loos et al.). The disclosed system in a lower plane, comprises a plurality of group conveyors with conveyor compartments, and above this, feed conveyors with grippers, said feed conveyors running transversely to the group conveyors, wherein each location at which a feed conveyor crosses a group conveyor, represents a possible feed location, where an object conveyed by the feed conveyor may be ejected into a conveyor compartment positioned therebelow. The control disclosed for the system, for each feed step, controls the coincidence of the object to be fed and the conveyor compartment and initiates each feed step by way of this control. If a feed step is not effected according to settings, the conveyor compartment concerned or the group conveyor concerned is stopped until a respective object is fed. This necessitates the group conveyors being able to be operated independently of one another.

It is the object of the invention to improve the system for putting together groups of flat objects, in particular printed products, as is described in the publication U.S. Pat. No. 4,484,733, to the extent that with this, a more efficiently operable and simply controllable composition of the groups of the flat objects is possible. With the help of the system according to the invention, it is also possible to compose the groups of flat objects with as small as possible expense with regard to devices and energy, wherein despite this the objects are ordered in the groups in a completely adequate manner for further processing, and feed errors may be corrected in a simple way and manner, so that no groups which are defective due to feed errors need to be discharged.

### BRIEF SUMMARY OF THE INVENTION

This object is achieved by the systems of putting together groups of flat objects, as is defined in the claims.

The system according to the invention for putting together groups of flat objects, thus as the system according to U.S. Pat. No. 4,484,733, has a matrix-like arrangement of a plurality of group conveyors, and a plurality of feed conveyors which are arranged above the group conveyors and cross the group conveyors. The system according to the invention is characterised by way of the fact that all mentioned conveyors are continuously operated and that the operation of all group conveyors is rigidly coupled to the operation of all feed conveyors. (Thereby, despite this however, it should be possible to apply each of the feed conveyors for a given production or also to put it out of service, thus completely decouple it). Moreover, the system according to the invention is characterised by way of the fact that the group conveyors and feed conveyors are equally directed at the feed locations and that the group conveyors as well as the feed conveyors may be led back. The steps for receiving the objects by way of the feed conveyors, for releasing the objects to the group conveyors and for releasing the groups to a path conveying or further processing, are cycled in a strict manner and are selectively carried out or suspended in a controlled manner, wherein the suspension of such steps in particular serves for the correction of feed errors, but may also, of course, be used for creating groups which are different from one another.

Since the feed conveyors and the group conveyors must run in an equally directed manner in the matrix-like arrangement of the system according to the invention, the term “matrix” in the present context is to be understood in a broader sense than is usual, specifically without the constraints of rectilinearity or parallelism of all matrix lines and the rectilinearity of all crossings of matrix lines. The matrix-like arrangement of group conveyors and feed conveyors of the system according to the invention, generally comprises “crossing regions” or “traversing regions”, wherein the feed conveyor on the one side of the group conveyor runs to the crossing region, runs in an equally directed manner with the group conveyor in the crossing region (feed location) and after the crossing region on the other side of the group conveyor runs away from this.

The group conveyors and feed conveyors of the system according to the invention are simple conveyors with revolving transport elements (e.g. chains), on which for example, for the feed conveyors, grippers for the essentially hanging conveying of the objects, and for the group conveyors, conveyor compartments in which the objects are stacked into groups in an essentially lying manner, are arranged in an equidistant manner. The operation of all group conveyors and feed conveyors is subjected to a system cycle, wherein a group conveyor cycle (time unit which is used in order to convey a group to the location of the leading group) is equally long as a feed cycle (time which is used in order to convey an object to be fed to the location of the leading object to be fed) multiplied by the number of group conveyors. Advantageously, but not necessarily, the distances between the conveyor compartments of all group conveyors are equally large, and the distances between the grippers of all feed conveyors are likewise equally large, so that all group conveyors may be operated with a same group conveyor speed, and all feed conveyors may be operated with an equal feed speed.

Since, for an ordered deposition of the objects into the conveyor compartments, with the transfer into the conveyor compartments of the group conveyors, it is advantageous if the speed of the objects is roughly as equally large as the group conveyor speed, the number of group conveyors is advantageous such that the group distances of the group conveyors is roughly equally as large as the gripper distances of the feed conveyors multiplied by the number of group conveyors. If this condition may not be fulfilled by a single feed device, it is however possible to supplement the feed conveyor at each feed location with a feed aid, wherein the feed aid takes over the objects from a main feed conveyor and accelerates or brakes them to a speed which is suitable for the deposition into the conveyor compartments. As will yet be shown, the feed aids may also assume further functions additionally to or in place of an accelerating or braking function.

An object may be deposited by a feed conveyor in a conveyor compartment of each feed conveyor in each group conveyor cycle. These feed steps for all group conveyors and feed conveyors may take their course exactly simultaneously or phase shifted.

The group conveyors advantageously comprise rests as conveyor compartments, which depending on the feed speed are provided with rear or front walls for the alignment of the objects deposited therein, wherein the rests may advantageously be orientated in a different manner for the deposition of the objects and for the release of the groups relative to the conveyor path. The group conveyors are capable of being led back, which means the release of the groups to a path conveying or further processing is selectively carried out or suspended, and a group which is not released, is conveyed back again to the entry of the matrix-like arrangement via the return section. Group conveyors with an upper conveyor section and a return section arranged therebelow are capable of being led back if the conveyor compartments are designed for a fixation of the groups during the leading-back, whilst the conveyor rest is positioned above the group. Group conveyors are inherently capable of being led back if the return section does not run below, but rather next to the conveyor section.

In particular, the conveyor devices which are disclosed in the Swiss patent application No. 1856/06 (F637) and in the international patent application which claims the priority of the mentioned Swiss patent application, are suitable as group conveyors of the system according to the invention. The disclosure of this application is contained within its full scope in the present application by way of reference.

The feed conveyors of the system according to the invention, for the matrix-like arrangement with feed locations, in which the group conveyors and the feed conveyors are equally directed (the same conveyor direction in a plan view), have a three-dimensional conveyor path, which means it is advantageously the case of conveyors with which curves in differently aligned planes and twists may be realised. Moreover, a leading-back capability is also required for the feed conveyors. As already mentioned further above in the context of the feed speed, all functions of the feed conveyor may be assumed in each case by way of a gripper conveyor known per se. However, it is also possible to supplement the gripper conveyor by way of feed aids, which are assigned in each case to a feed location. These feed aids may also assume the three-dimensionality of the feed path in addition to, or in place of the already mentioned acceleration and braking function, wherein they do not necessarily need to be capable of being led back. Such a division of the function of the feed conveyor, although necessitating the objects having to be transferred from the gripper conveyor to the feed aids, however permits the system to be realised with simpler devices and mostly in a more space-saving manner. The feed aid may however on the other hand have only a guide function, thus lead and align the objects which are fed in a hanging manner, only for the feed to the conveyor compartments of the group conveyor. In such a case, the feed aids are, for example, simple guidance plates.

Of course it is possible in the system according to the invention, to design the individual feed conveyors in a different manner, thus for example to apply feed aids which are adapted to format, stiffness and/or weight of the objects to be fed, or to design the conveyor paths of the gripper conveyors in a suitable manner. Thereby however, it is advantageous to select the same gripper distance for all gripper conveyors, in a manner such that all gripper conveyors may be operated at the same speed.

The feed conveyors are supplied with objects from object sources, wherein the object sources with regard to operation, at least in a limited manner, are independent of the matrix-like arrangement of feed conveyors and group conveyors, in a manner such that a supply from the source may be stopped for each object led back by a feed conveyor. This may be realised in a simple manner by way of sources, which are operated in the system cycle or may be controlled for the selective supply or suspension of the supply, or by way of object buffers, by way of which the object source with regard to operation is decoupled from the system cycle, which means to say, from the feed conveyor. Preferred object sources are, for example, winding stations known per se with intermediate buffers, controllable feeders or processing devices which are connected on-line to a feed conveyor and which are provided with an exit buffer or may be controlled for the production of gaps at the exit.

The error rectification in the system according to the invention for putting together groups of flat objects is designed for correcting errors which arise due to feed errors. If an object is not released to a group at a feed location because a gripper is empty (feed gap which may be detected by sensor), the feed steps at the subsequent feed locations are suspended and the group is led back, wherein with the second passage, the feed steps at all feed locations upstream of the error location are suspended. Objects, which although are fed, but are detected as faulty (multiple feeds or faulty or damaged objects which may likewise be detected by sensor) are not released by way of the non-opening of the respective gripper, and are discharged after the last feed location, for which suitable discharge means are provided. If not so high quality demands are placed on the created groups, the error rectification may be accordingly simpler. If the sequence of objects in the created group, for example, is of no relevance, then in the first passage of a defect group no additional feeds are suspended, and in the second passage all feeds are suspended except the feed which is affected by the feed error. This simplifies the error rectification due to the fact that one does not need to react so quickly to the feed errors. Of course it is also possible, of the plurality of feed conveyors, to design some for a more extensive and others for a less extensive error rectification, thus for example to provide some feed conveyors for example with means for detecting multiple objects and/or defect objects and means for their discharge, and others without these.

One may also create relatively heavy groups (e.g. up to a few kilograms) in the system according to the invention, with an acceptable energy consumption, by way of the continuous operation, in particular of the group conveyors.

### BRIEF DESCRIPTION OF THE DRAWINGS

Advantageous embodiments of the inventive system for putting together groups of flat objects are described in detail in combination with the following figures. Thereby, there are shown in:

FIG. 1 a first exemplary embodiment of the system according to the invention (plan view),

FIG. 2 a feed conveyor of the embodiment according to FIG. 1, with a viewing angle parallel to the group conveyors;

FIG. 3 the feed conveyors to a group conveyor of the system according to FIG. 1 (viewing angle transverse to the group conveyor);

FIG. 4 a further exemplary embodiment of the feed conveyor for the system according to FIG. 1 (viewing angle parallel to the group conveyors);

FIG. 5 a second, exemplary embodiment of the system according to the invention (plan view);

FIG. 6 the feed locations to a gripper conveyor of the system according to FIG. 5, with a viewing angle transverse to the gripper conveyor;

FIG. 7 a third exemplary embodiment of the system according to the invention (plan view);

FIG. 8 a feed location of the system according to FIG. 7, with a viewing angle transverse to the group conveyor.

### DETAILED DESCRIPTION OF THE INVENTION

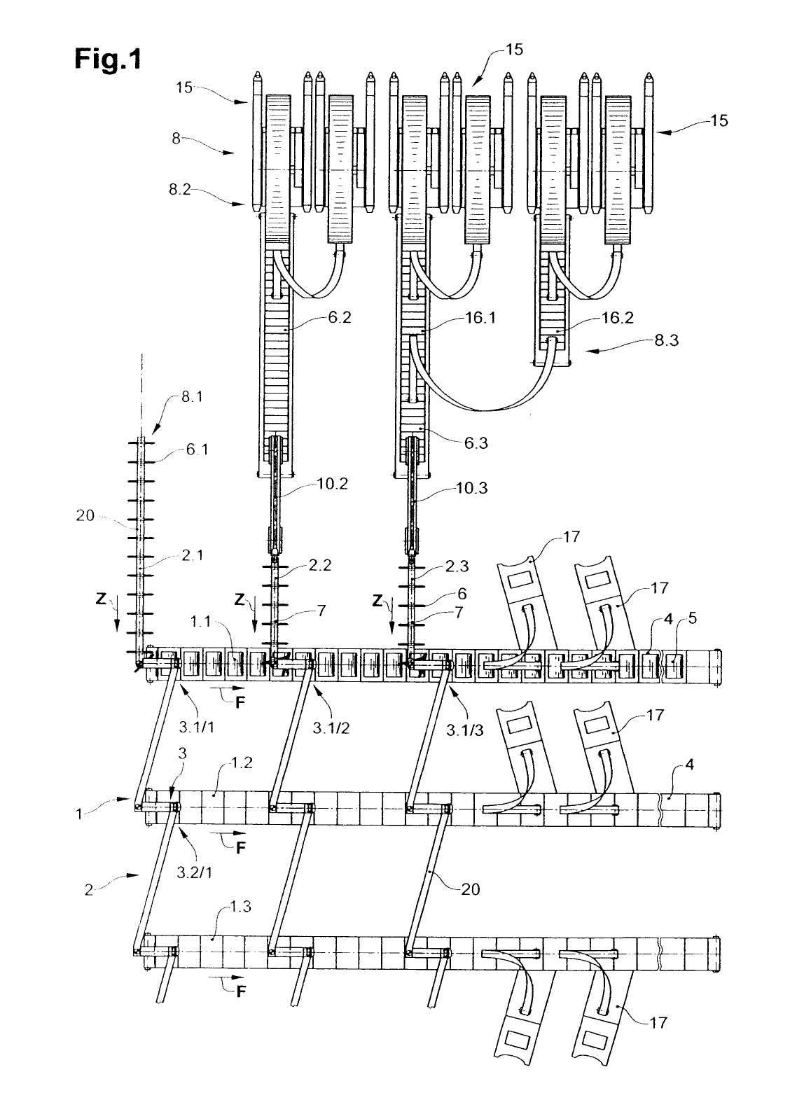

FIG. 1 shows a plan view of a first, exemplary embodiment of the system according to the invention. This comprises three equal group conveyors 1 (1.1, 1.2 and 1.3) which run from the left to the right in the figure, with equal conveyor speeds F, as well as three equal feed conveyors 2 (2.1, 2.2, 2.3) which are arranged over the group conveyors 1 and run essentially from the top to the bottom in the figure, with the equal feed speeds Z, which together form nine feed locations 3 (3.1/1, 3,1/2, 3.1/3, 3.2/1 . . . ). Since three group conveyors are provided, the feed performance of each feed conveyor 2 must be three times greater than the group performance of each group conveyor 1. Of course, numbers of group conveyors 1 and/or feed conveyors 2 which are different from three or also from one another, are also conceivable.

The group conveyor 1 comprises conveyor compartments 4 designed as rests, on which the fed flat objects 6 are stacked for creating the groups 5. The return section of the group conveyors 1 runs below the conveyor section in FIG. 1 from the right to the left and is therefore not visible. The conveyor compartments 4 are designed for firmly holding groups 5 which are conveyed through the return section, thus are led back. For example, at the right end of the conveyor section of the group conveyor 1 or any location of the return section, the groups 5 are selectively released to a path conveying or further processing or are conveyed back onto the conveyor section, where they are conveyed a second time through the feed locations 3.

After the release of the groups, these for example are enveloped in a packaging device with a film and then stacked. The stacks may additionally yet be hooped and then transported away.

The feed conveyors 2, for example, have known gripper conveyors 20, whose grippers 7 are designed for an essentially hanging conveying, whilst the flat objects 6 are aligned transversely to the conveyor direction and have relatively small distances from one another. The conveyor section of each feed conveyor 2 or gripper conveyor 20 begins at an object source 8 (8.1, 8.2 and 8.3), and crosses all group conveyors 1, wherein it lowers towards the respective group conveyor 1 for each feed location, and assumes a conveyor direction which is directed equally to the group conveying. This necessitates bends in essentially vertical and horizontal planes and twists between the bends.

The object source 8.2 which supplies the feed conveyors 2.2 with objects is a winding station 15 known per se, with two winding positions, of the type such that flat objects 6.2 from the one winding position are wound off from a winding, whilst an empty reel core may be replaced by a full reel in the other reel position. The objects 6.2 to be fed by the feed conveyor 2.2 are designed as an imbricate flow, are buffered at its head end (not visible in FIG. 1) and, for example, individualised by way of intermediate conveyors 10.2 and transferred to the grippers 7 of the feed conveyor 2.2.

The object source 8.3 supplying the feed conveyors 2.3 with objects is a combination of two winding stations 15, which in each case feed an imbricate flow 16.1 and 16.2 of objects. These imbricate flows are placed over one another in a synchronised manner and after a buffering (not represented), individual pairs of objects lying on one another (foregroups) are separated from imbricate flows lying on one another by way of an intermediate conveyor 10.3, and are transferred as objects to be fed 6.3 from the intermediate conveyor 10.3 to the grippers 7 of the feed conveyor 2.3.

The object source 8.1 which supplies the feed conveyors 2.1 with objects 6.1 is not represented. Here again, it may be the case of a winding station or of a feeder or however of an on-line feed from a processing device, wherein the processing device is operated with the same cycle as the feed conveyor and may be controlled for supply gaps aligned to return feeds or wherein a buffer is provided between the processing device and the feed conveyor. In the mentioned manner for example, collating devices or insert devices (e.g. drums) are conceivable as object sources, in which the foregroups are created, or also cutting devices or stitching devices or other processing devices. It is also possible to supply a feed conveyor online from the rotary printing press if the supply connection has a buffer. As the case may be, an on-line feed, for example, from the rotation may also be applied without buffer, by which means then this feed conveyor would not be capable of being led back, so that objects which are not to be fed would have to be discharged somewhere on the return line.

The system according to FIG. 1 further shows feeders 17 assigned to each group conveyor 1. Of course, also other additional feed devices assigned to only individual group conveyors are possible, wherein these however do not belong to the matrix-like arrangement of the system according to the invention.

The gripper conveyors 20 of the feed conveyor 2 of the system according to FIG. 1 are, for example, gripper conveyors which are common in mailroom technology, with a gripper distance of 100 mm. For example, a conveyor compartment length (conveyor compartment distance) of about 300 mm is conceivable for the group conveyor 1, for putting together groups of normal-format printed products. This in the case of three group conveyors for the group conveyor 1 results in a conveyor path per system cycle of about 300 mm, and for the gripper conveyors 20 of, in each case, three times 100 mm, or roughly the same speed for all conveyors. A direct transfer of gripper conveyors to the conveyor compartments of the group conveyors (without accelerating or braking effect of a feed aid) is conceivable in this case.

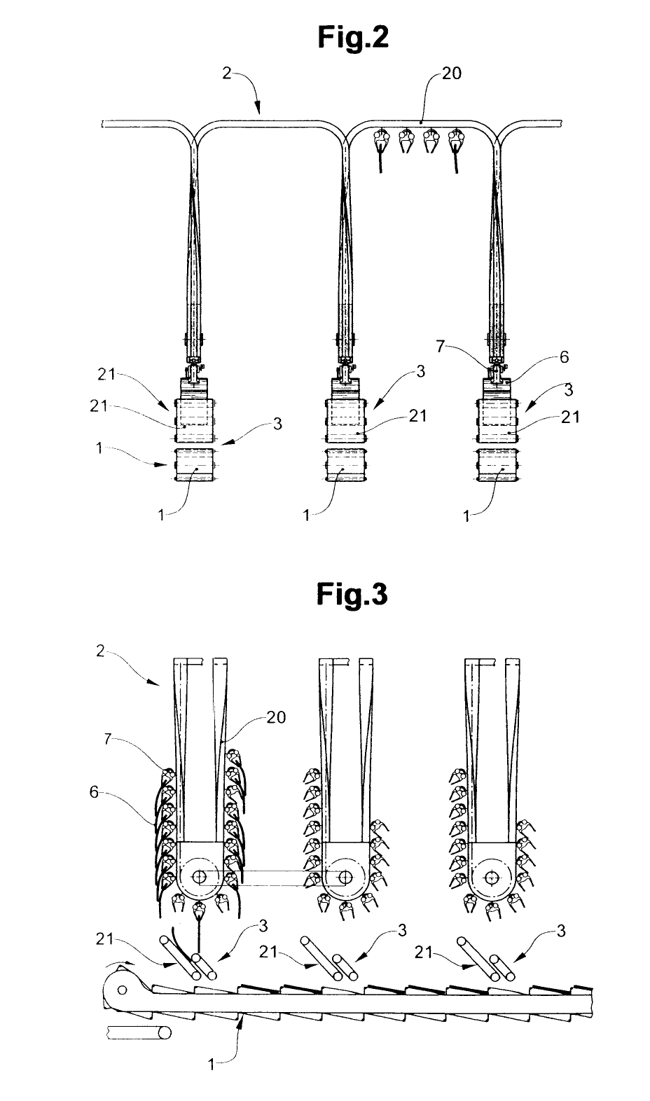

FIGS. 2 and 3 of the system according to FIG. 1, in each case show a part of the feed conveyors 2, the feed locations 3 and the group conveyors 1. In FIG. 2, a feed conveyor 2 with its three feed locations 3 to the group conveyors (1.1, 1.2 and 1.3) are represented at a viewing angle parallel to the group conveyors. In FIG. 3, the feed locations 3 to a group conveyor are represented with a viewing angle transverse to the group conveyor 1. The feed conveyors 2 again comprise a gripper conveyor 20 as well as feed aids 21 which are designed as double belts, are assigned to the feed locations 3 and by way of which the objects to be fed 6, on the one hand are aligned for the feeding, and on the other hand, as the case may be, are brought from the speed of the gripper conveyor 20 to a different speed which is better adapted to the conveyor speed of the group conveyor.

The twisting of the gripper conveyor 20 is clearly visible from FIG. 2. The grippers 7 and objects 6, which are represented only partly, are aligned between the feed locations 3 essentially transversely to the plane of the paper, and are parallel to the plane of the paper at the feed locations. At each of the feed locations 3, each third gripper 7 is opened in a manner such that after the third feed location, in the absence of returns, all grippers are opened and no more objects are conveyed.

A suspension of the feed is achieved by way of the respective gripper 7 of the gripper conveyor 20 not being opened, and the respective object 6, instead of being gripped by the feed aid 21 and released to the group conveyor 1, being conveyed further by the gripper conveyor 20. Evidently, the feed aids 21 designed as double belts are not capable of being led back, so that an object 6 which is once released to the feed aid may no longer be led back. If a feed error occurs at a feed location which is adjacent upstream, a feed at the observed feed location may now only be suspended if the object concerned at a point in time at which the control has detected the feed error and led this further, is not yet gripped by the feed aid 21 which is not capable of being led back. This is very easily possible, for example, in the system according to FIG. 1, as well as in the embodiment according to FIG. 3, since for example about six or three system cycles (distance between two consecutive feed locations correspond roughly to about six or three conveyor compartment distances) pass between consecutive feeds to a group conveyor, and the feed aid 18 in each system cycle handles only one object.

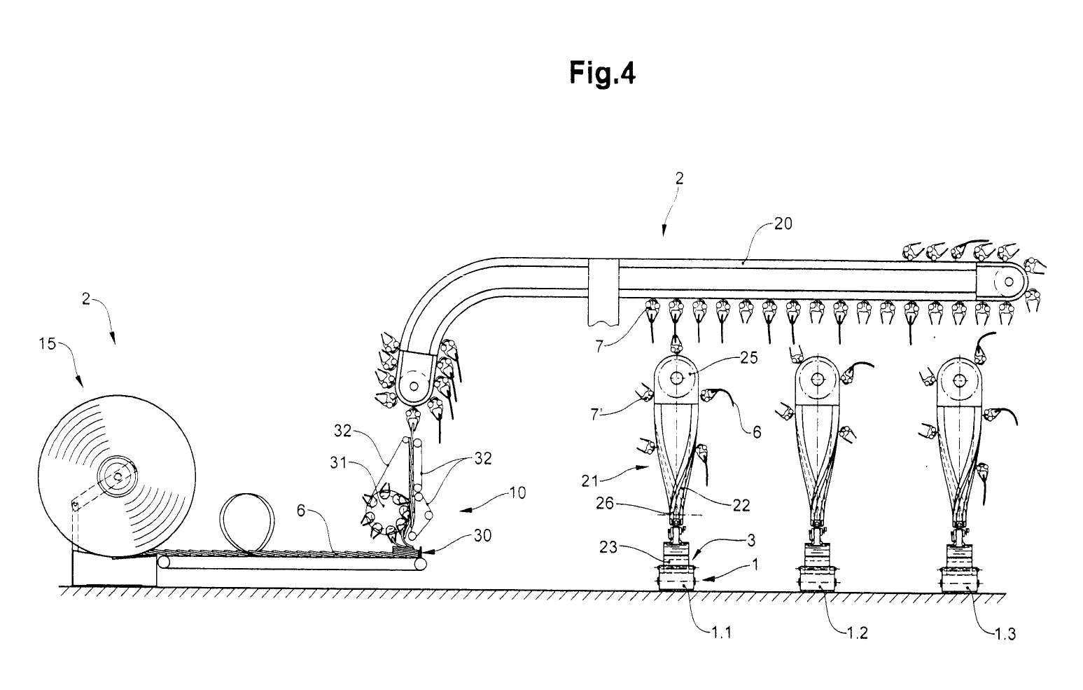

FIG. 4 shows a further exemplary feed conveyor 2 which may be applied in a similar manner as the feed conveyor according to FIGS. 2 and 3 in the system according to FIG. 1. The feed conveyor 2 is represented with a viewing direction parallel to the group conveyors 1 (1.1, 1.2 and 1.3), together with an exemplary object source 8 with winding stations 15, buffer means 30 and intermediate conveyors 10. The buffer means 30 consists, for example, of a simple stop, at which the imbricate flow of flat objects 6 fed by the winding station 15 is dammed into a stack. The intermediate conveyor 10 comprises a gripper wheel 31 and a plurality of conveyor belts 32 cooperating therewith. The winding station 15, the buffer means 30, and the intermediate conveyor 10 are elements known per se and for this reason are not described here in a detailed manner. It is likewise known to the man skilled in the art, to realise other object sources 8 in an equivalent manner.

The feed conveyor 2 according to FIG. 4 differs from the feed conveyors represented in FIGS. 2 and 3, in particular by way of a different functional division between the gripper conveyors 20 and the feed aids 21. In particular, the conveyor path of the gripper conveyor 20 does not run in a three dimensional manner, but merely in an essentially perpendicular plane, whilst the feed aids 21 which are designed as further gripper conveyors 22 with grippers 7′, have a three-dimensional conveyor path and twists. In addition to the further gripper conveyors 22, the feed aids 21 may yet comprise double belts 23 as are represented in FIGS. 2 and 3. The further gripper conveyor 22 is wound in a manner such that at the top it runs equally directed with the gripper conveyor 21, and at the bottom equally directed with the group conveyor 1. The further gripper conveyor 22, for example, comprises two deflection wheels 25 and 26, whose axes are not aligned parallel to one another, but for example perpendicular to one another.

Thanks to the suitably designed feed aids 21 of the feed conveyor 2 according to FIG. 4, the gripper conveyor 20 may thus be aligned perpendicularly to the group conveyors 1.1, 1.2 and 1.3 and run over these at an essentially constant height.

If less objects are on their way between the transfer of the objects 6 from the gripper conveyor 20 to the further gripper conveyor 22 of the feed aid 21 and the release of the objects to the group conveyor 1, than conveyor compartments between two consecutive feed locations at a group conveyor, for feed aids as described with regard to FIGS. 2 and 3, it is not necessary for these to be capable of being led back. Despite this, a feed following a feed location which is affected by a feed error, may be suspended by way of the respective object not being transferred to the feed aid 21, but being led back by the gripper transporter 20. In this case, the feed aid 21 instead of the further gripper conveyor 22, may have a pair of conveyor belts which are pressed on one another and suitably wound, which are not capable of being led back.

If the above-mentioned condition of the length (in objects) of the feed aids 21 is not fulfilled, the feed aid must be capable of being led back for a complete error correction, so that releases to the group conveyor may be suspended in all events.

A further variant of error correction for “too long” feed aids which are not capable of being led back lies in continuing to lead objects to a group which is affected by a feed error, and in a second passage (after leading back by the group conveyor) of still feeding the object which is not added due to the feed error, and suspending all other feeds. The led-back group then contains the correct objects, but these in the stack have a different sequence than in a group created without any errors.

Evidently, for groups of printed products, for individual ones of the products, in particular the printed product which is uppermost and lowermost in the stack, it is important for them to have the correct position, and this is less important for intermediately lying printed products. In such a case, the error rectification for different feed conveyors may be designed in a different manner and accordingly different feed aids may be applied.

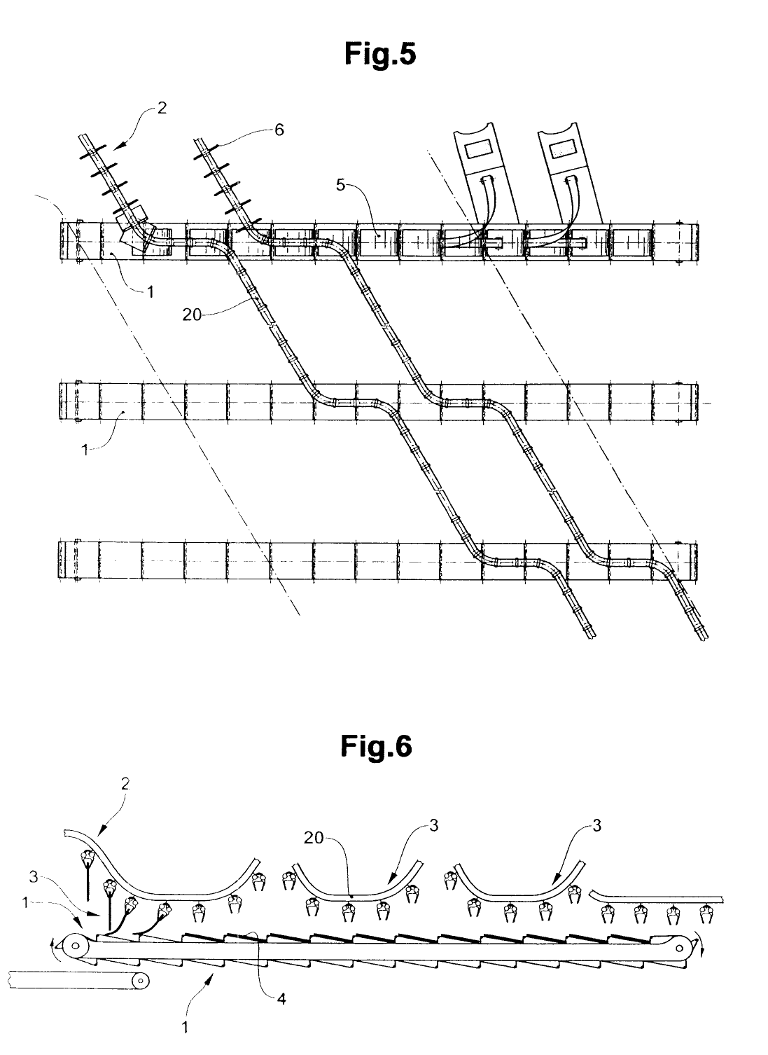

FIGS. 5 and 6 show a further, exemplary embodiment of the system according to the invention for putting together groups 5 of flat objects 6, wherein the system as shown, may comprise three group conveyors 1 and two feed conveyors 2. Thereby, the number of feed conveyors 2 in principle is not limited, and the maximum number of the group conveyors 1 is determined essentially by the maximal capacity of the individual feed conveyors 2. FIG. 5 is a plan view of the system which is represented without object sources. FIG. 6 shows the feed locations 3 of the feed conveyor 2 to one of the group conveyors 1 (viewing direction transverse to the group conveyor). The same elements are indicated with the same reference numerals as in the preceding figures and are yet only described where necessary.

In contrast to the system according to FIG. 1, the feed conveyors 2 in the system according to FIG. 5 generally run obliquely to the group conveyors 1, which for a matrix-like arrangement with the same amount of feed locations, demands somewhat more space, but results in simpler conveyor paths for the feed conveyors 2. The larger space requirement may likewise be compensated by way of not arranging the group conveyors 1 in a rectangle, but in a rhomboid (indicated by dot-dashed lines).

It is evident from FIG. 6 that in the embodiment of the system according to the invention according to FIG. 5, it is simply possible to deposit the objects directly into the conveyor compartments 4 of the group conveyors 1 by way of the gripper conveyors 20, thus without feed aids. Thereby however, as already mentioned further above, one should take care that by way of a suitable choice of the gripper distances, of the conveyor compartment distances and/or the number of group conveyors for the gripper conveyor 20, a speed is possible for the gripper conveyor 20 which is not much different from the group speed, in a manner such that an ordered deposition of the objects in the conveyor compartments 4 is possible.

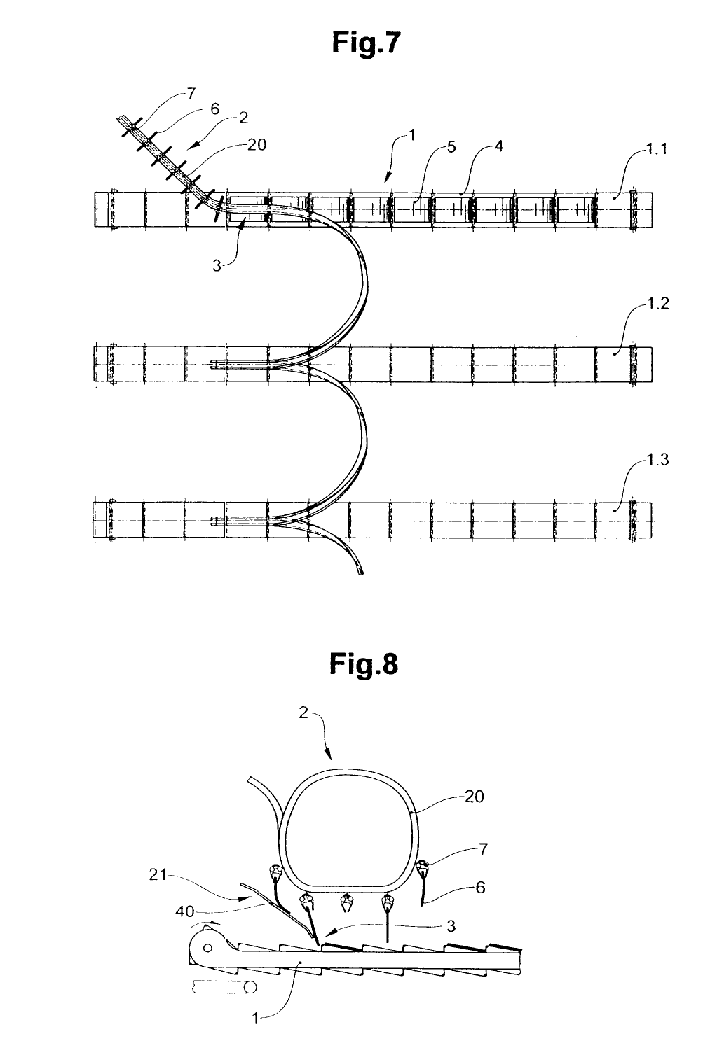

FIGS. 7 and 8 show a further, exemplary embodiment of the system according to the invention for putting together groups 5 of flat objects 6. The manner of representation is essentially the same as in the FIGS. 5 and 6. The same elements are indicated with the same reference numerals as in the preceding figures and are now only described where necessary. The embodiments according to FIGS. 7 and 8 also differ from the embodiment according to FIG. 1 essentially by way of the course of the gripper conveyors 20 of the feed conveyors 2 (only one shown). These gripper conveyors 20 run essentially in a lying spiral over the group conveyors 1, wherein the lowermost location of each spiral winding is arranged above a group conveyor 1 and represents the feed location 3.

As is evident from FIG. 8, it is also possible in this embodiment to release the objects 6 essentially directly from the gripper conveyors 20 to the group conveyors, wherein, as the case may be, a feed aid 21 in the form of a simple guidance plate 40 may be provided for a suitable orientation of the freely hanging objects 6.

1. A system for putting together groups (5) of flat objects (6), said system comprising a matrix-like arrangement of a plurality of continuously operated group conveyors (1) capable of being led back, and of a plurality of continuously operated feed conveyors (2) that are capable of being led back and that are supplied with objects (6) in each case from an object source (8), wherein the feed conveyors (2) are arranged above the grouped conveyors (1) and cross said grouped conveyors in a region of feed locations (3), wherein the feed conveyors (2) are equally directed with the group conveyors at the feed locations, wherein the group conveyors (12) and the feed conveyors (2) are operated coupled to one another via a system cycle and wherein the system additionally comprises a control, by way of which steps for receiving objects (6) from the object sources (8) by the feed conveyors (2), steps for releasing objects (6) to the group conveyors (1) by the feed conveyors (2) and steps for transferring groups (5) from the group conveyors (1) to further conveyors or processing stations may be carried out or suspended in a selective manner.

2. The system according to claim 1, wherein all group conveyors (1) have a transport member and conveyor compartments (4) arranged equidistantly thereon, and all feed conveyors (2) comprise a group conveyor (20) with a transport member and grippers (7) arranged equidistantly thereon.

3. The system according to claim 2, wherein the conveyor compartments (4) of all group conveyors (1) have the same distances to one another, and the grippers (7) of all gripper conveyors (20) have the same distance to one another.

4. The system according to claim 1, wherein the feed conveyors (2) at each feed location (3) comprise a feed aid (21) arranged between the gripper conveyor (20) and the group conveyor (1).

5. The system according to claim 4, wherein the feed aids (21) are guide plates (40).

6. The system according to claim 4, wherein the feed aids are double belts or further gripper conveyors (22).

7. The system according to claim 6, wherein the double belts or the further gripper conveyors (22) are operated at a speed which is different that a speed of the gripper conveyor (20).

8. The system according to claim 6, wherein the double belts or further gripper conveyors (22) are twisting.

9. The system according to claim 8, wherein the further gripper conveyors (22) comprise an upper and a lower deflection wheel and an axis of the upper deflection wheel is aligned transversely to the gripper conveyor (20) and an axis of the lower deflection wheel is aligned transversely to the group conveyor (1).

10. The system according to claim 1, wherein sensors are provided to detect feed gaps.

11. The system according to claim 1, wherein sensors to detect multiply fed and/or defective objects are provided, and the feed conveyors (2) comprise means for discharging said multiply fed and/or defective objects.

12. The system according to claim 1, wherein the object sources (8) are operated at least partly in a non-system cycle, and buffer means (30) are arranged between the object sources (8) and the feed conveyors (2).

13. The system according to claim 1, wherein at least a part of the object sources (8) is operated in the system cycle and a supply of an object (6) may be suspended in given cycles.

14. The system according to claim 1, wherein at least a part of the object sources (8) comprises a winding station (15), a plurality of winding stations, a feeder, a collation device or insertion device, a processing device or an on-line connection to a rotary printing press.

15-17. (canceled)
